(19) United States
(12) Patent Application Publication
(10) Pub. No.: US 2004/0029572 A1
(43) Pub. Date: Feb. 12, 2004

(54) Method and system for selecting on request one or several data sources available from a communication network

(76) Inventor: Olivier Nerot, Doussard (FR)

Correspondence Address: HARRISON & EGBERT, 412 MAIN STREET, 7TH FLOOR, HOUSTON, TX, 77002, US

(21) Appl. No.: 10/296,762

(22) PCT Filed: Jun. 14, 2001
(86) PCT No.: PCT/FR01/01855

(30) Foreign Application Priority Data
Jun. 14, 2000 (FR) 0007573

(51) Int. Cl. H04Q 7/20

(52) U.S. Cl. 455/414.3; 455/414.1; 455/422.1; 455/41.2; 455/426.2

(57) ABSTRACT

The invention concerns a method for selecting upon request one or several information sources (6) available from a communication network, such as, notably, the worldwide web, a method wherein:

a contact base is assigned to each member of a group of users (1) of said network, whereas said base is composed of a list of identification addresses on the network, so-called network addresses, of at least some of said users and, a resource base is assigned to at least a portion of said group of users, whereas said resource base is composed of one or several lists of access means to said information sources (6),

each request is broadcast iteratively from the user(s) (1_{b}) whom it reaches, to the users (1_{c}), some of them or all of them, of their contact base, so-called consulted users,

at least said resource base of each user (1_{b}, 1_{c}) consulted is processed to reply to the request.

The invention also concerns a software product recorded on a medium useable in a digital processing device, intended for the implementation of the method described above.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns a method and a system for selecting upon request one or several information sources available from a communication network, as well as a software product recorded on a medium useable in a digital processing device, intended for the implementation of such a method.

Although more particularly intended for usage with the worldwide web, the invention could also be applied to any other type of communication network from which several information sources are accessible.

### BACKGROUND OF THE INVENTION

Currently, to select information on the worldwide web, computer tools, called “search engines” are known, which enable to provide a user with a list of links to information sources such as, for example, sites, data pages or others.

These search engines operate from a central server which scans permanently the available data on the worldwide web. To this end, it uses one or several initial pages and explores the data found while scrolling from page to page in relation to the links extant in the pages found.

Upon a user's request, the links thus listed are scrutinized and those corresponding to the request are transmitted to the user.

A first shortcoming of such tools lies in the uniformity of the replies given. Indeed, for the same request, the list of links supplied is still the same, regardless of the user.

Besides, it should be noted that the defects of the central server are particularly critical since no searches can be carried out any longer.

One can also note that the indexing task, i.e. updating the links, is particularly cumbersome and tedious for the central server, whereas this task is entirely dedicated thereto. It is moreover limited since the worldwide web possesses portions which centralized servers cannot access.

It is an object of the invention to offer a method and a system for selecting upon request one or several information sources available from a communication network; such as, notably, the worldwide web, as well as a software product recorded on a medium useable in a digital processing device, intended for the implementation of such a method, which remedy the shortcomings aforementioned and enable to customize the replies to the requests.

Another object of this invention is to offer a method and a system for selecting upon request one or several information sources available from a communication network; such as, notably, the worldwide web, as well as a software product recorded on a medium useable in a digital processing device, intended for the implementation of said method, whereof the reliability is enhanced.

Another object of this invention is to offer a method and a system for selecting upon request one or several information sources available from a communication network; such as, notably, the worldwide web, as well as a software product recorded on a medium useable in a digital processing device, intended for the implementation of said method, which facilitate the indexing of the information sources.

Other objects and advantages of the invention will appear in the following description, given only for illustrative purposes, without being limited thereto.

### BRIEF SUMMARY OF THE INVENTION

The invention concerns first of all a method for selecting upon request one or several information sources available from a communication network, such as, notably, the worldwide web, a method wherein:

a contact base is assigned to each member of a group of users of said network, whereas said base consists of a list of identification addresses on the network, so-called network addresses, of at least some of said users and, a resource base is assigned to at least a portion of said group of users, whereas said resource base is composed of one or several lists of access means to said information sources,

each request is broadcast iteratively from the user(s) whom it reaches, to the users, some of them or all of them, of their contact base, so-called consulted users, and

at least said resource base of each user consulted is processed to reply to the request.

The invention also concerns a software product recorded on a medium useable in a digital processing device, intended for the implementation of the method described above, whereas said product comprises:

means to provide a user, connected to a digital communication network by said processing device, with a contact base, composed of a list of the network addresses of the users of said network, and with a resource base, composed of one or several list of access means to information sources available from said network,

means to broadcast a request from said user to the users, some of them or all of them, of its contact base, and

means to process its resource base, to reply to the request.

The invention still concerns a system for the implementation of the method described above, comprising a plurality of digital processing devices loaded with said software product evoked previously and defining a group of users of said network.

### BRIEF DESCRIPTION OF THE SEVERAL VIEWS OF THE DRAWINGS

The invention will be better understood when reading the following description accompanied by the appended drawings whereon:

FIG. 1 describes as a functional block diagram an embodiment example of the software product according to the invention.

FIG. 2 describes schematically an implementation of example of the method and system for selecting upon request one or several information sources, according to the invention, using the software product of FIG. 1.

### DETAILED DESCRIPTION OF THE INVENTION

The invention concerns first of all a method for selecting upon request one or several information sources available from a communication network. It can be, for instance, the worldwide web.

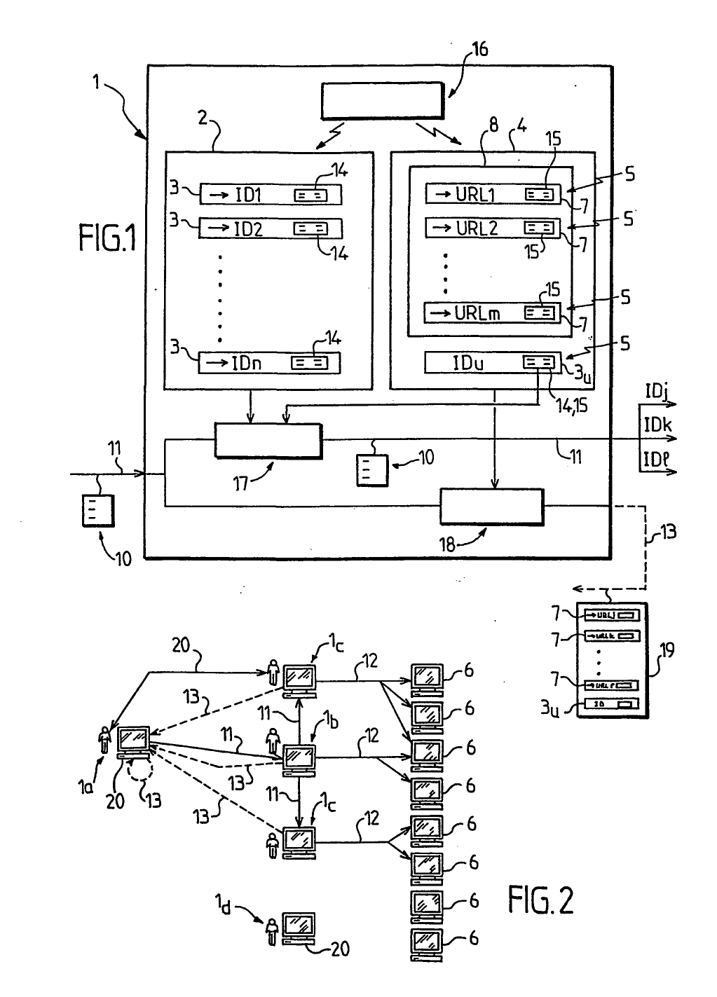

As illustrated on FIG. 1, according to said method, each member of a group of users 1 of said network is provided with a contact base 2, composed of a list of identification addresses on the network, so-called network addresses 3, of at least some of said users and, for at least some members of said user group, with a resource base 4, composed of one or several lists of access means 5 to said information sources.

Said information sources are composed, for example, of data in the form of sites, pages or others 6, notably tagged by their URL.

The access means 5 are composed for example of at least links 7 to said data, i.e. instructions enabling to access said data by its URL. Said resource base comprises thus, among other things, a link base 8.

The information sources 6 accessible from the links 7 listed in said link base 8 are, at some of them, remote, i.e. in a point different in the network from that of the user owner of said link base. Said sources could besides be spread over several points in the network, as shown on FIG. 2.

It could also be user personal data that it may wish to render accessible n the network.

Said information sources could then be the users properly speaking and the resource base 4 may comprise, as access means 5, at least the network address 3ᵤ of the user owner of said resource base 4.

The reply 19 to the request may notably include lists of links and/or lists of network addresses, i.e. users.

To this end, as illustrated on FIG. 2, each request, symbolized by the arrows marked 11, is broadcast iteratively from the user(s) 1_{b} whom it reaches, towards the users 1_{c}, some or all of them, of their contact base, so-called consulted users, and at least said resource base of each user consulter 1_{b}, 1_{c} is processed, when said user possesses a resource base, as symbolized by the arrows marked 12, to reply to the request.

The search task is then distributed to each user and it is not necessary any longer to resort to a centralized server, which enables to solve the related problems. Indeed, the replies to the requests are customized, the operation of the search is made more reliable and the indexing of the information sources is facilitated thanks to the broadcasting mechanism of the requests and to the distribution of information to each user.

It should be noted besides that the resource base 4, being composed of lists of access means to information sources, possibly remote sources, enables to have not only local information, but also information external to each of the users consulted and even external to said user groups, so that their own memory is not overloaded and benefit from their experience.

Besides, some users may decide not to have their own network addresses listed in their resource base. They may then remain anonymous or even not possess link bases and serve only as relays for the broadcasting requests.

The replies are supplied, for instance, in the form of a list of access means selected in relation to the request. To discover the content and/or come in contact with the related information sources, it then suffices, notably, to display said access means 5 and to activate them, for example using a pointer.

To process the resource base 4 of the users consulted, one may review its access means 5 and sort them according to the request.

Said request is transmitted, for example, upon the initiative of one of said users 1ₐ to whom the reply is given. In this view, one may send the same reply to other users, designated accordingly. One may then contemplate “group” searches.

Similarly, one may inform the users consulted 1_{b}, 1_{c}, of the experience of the user 1ₐ at the origin of the request.

The reply is sent to the user 1ₐ at the origin of the request, for instance, in portions from each user 1_{b}, 1_{c}, consulted, as symbolized by the arrows illustrated as a dotted line 13. To this end, the own resource base of the user 1 at the origin of the request may also be processed for the reply.

A request is broadcast, notably, according to a number of iterations after which it stops, regardless of the number of replies. To this end, one may test the presence of reply from the users consulted 1_{b}, 1_{c}, and reformulate the request at a later stage towards those detected as absent, i.e. for example off-line.

Advantageously, as illustrated on FIG. 1, each user will be assigned a profile 14 characterizing said user, for example, by its interests and/or its socio-professional profile. Said profile 14 is situated for example at its user address 34.

In order to target the reply still more accurately, one may also broadcast the request only by means of the users consulted whereof the profile corresponds to the request.

To chose the access means 5 retained in reply to a request and/or the study of a profile matching a request, one may for example assign to each means of selection 7 a list of one or several keywords, called tag 15, characterizing the information source related. In the case of links 7, the tag 15 associated comprises, for example, keywords describing the content of the corresponding data. In the case of the network address 3ᵤ of the user owner of the resource base 4 wherein said network address is inserted, said tag 15 corresponds, notably to its profile 14, also in the form of a list of keywords.

As the requests are also formulated by keywords, the resource base 4 of the users is processed by comparison of the keywords of the request and of the keywords of said tags 15 and/or profile 14 to sort the access means 5 retained.

One may also assign to each keyword of said tags 15 and/or profile 14 an index characterizing its significance in the related information source and exhibit in reply to the request a list of access means 5 classified in relation to the indices of their keywords.

Each network address 3 can also be fitted with the contact base of the profile 14 of the related user and the display of said contact base can be organized in relation to the indices of their keywords, for selected keywords.

According to an advantageous embodiment, which may be combined to the embodiment aforementioned, the user(s) having received a reply to the request are allowed to enrich their contact base and/or their resource base with the results from said request. Information acquired can then be traced and the experience built upon.

In particular, said user may insert in his resource base 4 access means 5 in whole or in part, notably links 7, listed in the reply and/or insert in his contact base 2 the network addresses 3, in whole or in part, which may also be included in the reply.

To this end, the list of the network addresses inserted in the contact base 2 can result from a sorting operation carried out according to the profile of the users consulted. In this view, the reply to the request includes the list of the network addresses of the users consulted whereof the profile corresponds to the request and, after reception of the reply by the user, he is offered to add said list selected to his contact base. It is not necessary any longer to proceed to a manual sorting operation and the contact base is updated to suit the user's requirements.

As regards updating the resource base, and more particularly the link base 8, it can be carried out according to the content of the tags 15 of the links found.

One may also contemplate updating the profiles. To do so, for example, one detects the profile matching each user and his contact base and/or his resource base and said user is offered an update in case of mismatch.

It should be noted that if said user rejects that option, the same person may be offered to have several user entities available, each fitted with his own contact base, his own resource base and/or his own profile and having a new network address.

To this end, a user's network address can be composed of an identifier (ID) comprising his physical address on the network (IP) possibly completed by additional identification means enabling to distinguish among several users working from the same physical address.

Thanks to said profile 14, one may also enable said user to send a message to a selected number of the other users by successive broadcast of said message, whereas the selection is made according to the profile of the users consulted. Such messages are thus broadcast in the same fashion as a request, whereas however the resource base of the users consulted is not processed and no replies are fed back. Consequently, messages are sent to addressee groups who are specified not by their addresses, but by their profiles.

On may also enable the users to establish a link with any user in their contact base as symbolized by the arrow marked 20. One proceeds for instance by displaying said contact base and selecting one or several items using a pointer. A mutual prior authorization can be made necessary to this end.

According to a particular embodiment, one may test, possibly periodically, the access means 5 of the users and notify to the user(s) affected the access means 5 become inefficient, notably the links 7 broken. This portion of the indexing task is therefore distributed to the user.

Consequently, the users may be offered libraries of lists of contacts and/or access means, available from a central server, not represented, connected to the network. Profile libraries may also be available from said server. The lists of contacts and/or access means can then be classified according to given profiles.

Such lists are, for example, are used upon arrival of such a user ion said user group.

Thus, a user arriving among the user group can ask for a contact base to be downloaded from the server, a contact base corresponding to users sharing the same interests as he does. He may then broadcast his requests using said contact base, then create then enrich his resource base gradually according to the information obtained. He may also contact the users, via a messaging service, of interest to him according to the information gathered, whereas the choice of such users is made according to their profiles. In parallel, the profile of such user will be created and will evolve according to his contact base and/or his resource base, or still manually.

Consequently, the resources bases and/or the contact bases of each user can be exported, by example periodically from the central server, notably after agreement thereof. The same may go for their profiles.

The users are then enabled to build back-up copies. The libraries can also be updated. Thus, the central server is dispensed with any indexing tasks. One will also be able to build in the central server a contact base and a link base made accessible to the users and merging their own contact bases and link bases.

It should be noted that initially the central server can be fed with links from other search engines. Similarly, each user newly arrived among said user group, if he had links previously, will be able to integrate them into the link base of his resource base.

In the central server, one may establish the list of the user listing the access means 5 to one of said information source 6 given in their resource base. One may thus notify said users of a possible update of said access means 5, for example via the central server, from the time when the user will have been notified of the new address towards which the updated access means 5 must be directed, which may take place at the initiative of any of the users.

The list of users available in the central server may also be processed, in case of agreement of said users, to supply to the information sources affected global indications on the population who consult said information, notably derived from the user profiles.

One may still notify the information sources 6 whereof the access means have been recorded in the resource base of one or several of said users, of references of said users, still after agreement and via the central server.

The central server may also be used to save the requests to which some of the users consulted have not replied since they were absent from the network, and to transmit these requests again to terminate the interrogation.

The invention concerns still a software product recorded on a medium useable in a digital processing device, intended for the implementation of the method described above.

Said software product comprises means 16 to provide a user connected to a digital communication network by said processing device, with a contact base 2, composed of a list of the network addresses of users of said network and of a resource base 4, composed of one or several lists of access means to information sources available from said network.

Said software product still comprises means 17 to broadcast a request from said user towards users, of his contact base, some or all of them, as well as means 18 to process his resource base, to reply to the request.

Said software product may also comprise, possibly, means for performing the various embodiments of the process aforementioned, not involving the central server. It will be thus means, for example, associated with the processing of his resource base, the transmission of the requests and the reception of the replies, the supply of information on the requests broadcast, the reformulation thereof, the assignment of a profile to the user and the different usages of said profile, the update of the contact bases, of the resources bases and/or of said profile, the realization of messaging service type exchange and/or the testing of the access means and of the signaling of those become inefficient.

The invention still concerns a system for implementing the method described above. It comprises therefore a plurality of digital processing devices loaded with the software product mentioned above and defining together a user group of the network.

Said digital processing devices are composed, for example, of a micro-computer. It may also be, notably, digital mobile phones.

Before use, said product is for example recorded on a floppy and/or in the memory of a central server in order to be downloaded.

In use, it is recorded, notably, on the hard drive of the micro-computer employed.

Said central server may exhibit the different functionalities already indicated such as, notably, the supply of libraries of contact bases, resource bases and/or profiles, updating said libraries by downloading each of the user bases, managing user lists having a same information source among their resource bases and broadcasting messages on the possible update of access means.

It is said software product which may supply said users with their identification address on the network, in relation to those granted previously and to their physical address on the network.

Naturally, other embodiments, obvious to the man of the art, could have been contemplated without departing from the framework of the invention.

I claim:

1. A method for selecting upon request one or several information sources (6) available from a communication network, such as, notably, the worldwide web, a method wherein:
a contact base (2) is assigned to each member of a group of users (1) of said network, whereas said base is composed of a list of identification addresses on the network, so-called network addresses (3), of at least some of said users and, a resource base (4) is assigned to at least a portion of said group of users, whereas said resource base is composed of one or several lists of access means (5) to said information sources (6),
each request is broadcast iteratively from the user(s) (1_{b}) whom it reaches, to the users (1_{c}), some of them or all of them, of their contact base, so-called consulted users,
at least said resource base of each user (1_{b}, 1_{c}) consulted is processed to reply to the request.

2. A method according to claim 1, wherein said access means consist of link instructions and, for some or all of the users provided with a resource base, the information sources 6 accessible via link instructions from a resource base of the same user are distributed into several points of the network.

3. A method according to claim 1 or 2, wherein, after reception of the reply by one of said users, he is able to enrich at least his contact base (2) and/or his resource base (4) with the results of the request.

4. A method according to any of the previous claims, wherein the access means (5) of the resource base (4) of the users consulted are reviewed and the said access means are sorted according to the request.

5. A method according to any of the previous claims, wherein the request is transmitted upon the initiative of one (1ₐ) of said users and the reply is given to at least said user (1ₐ), in the form of a list of access means (5) selected according to the request.

6. A method according to claim 5, wherein one informs the users consulted (1_{b}, 1_{c}) of the experience of the user (1ₐ) at the origin of the request.

7. A method according to any of the previous claims, wherein the reply is sent in portions to the user (1ₐ) at the origin of the request, from each user (1_{b}, 1_{c}) consulted.

8. A method according to any of the previous claims, wherein the presence of reply from the users consulted (1_{b}, 1_{c}) is tested and the request is reformulated at a later stage towards those detected as absent

9. A method according to any of the previous claims, wherein each user is assigned a profile (14) characterizing said user.

10. A method according to claim 9, wherein the request is broadcast only by means of the users consulted whereof the profile corresponds to the request.

11. A method according to claim 9, wherein the reply to the request includes the list of the network addresses (3) of the users consulted whereof the profile corresponds to the request and, after reception of the reply by the user, he is offered to add said list selected to his contact base

12. A method according to claim 9, wherein one detects the profile matching the contact base and/or the resource base of the users and the users are offered to update their profiles in case of mismatch.

13. A method according to claim 9, wherein any of said users is allowed to send a message to a selected number of the other users by successive broadcast of said message, according to the profile of the users consulted

14. A method according to any of the previous claims, wherein the users are allowed to establish a link with any user in their contact base.

15. A method according to any of the previous claims, wherein the access means (5) of the users are tested the user(s) affected is(are) notified of the access means become inefficient.

16. A method according to any of the previous claims, wherein the users are offered libraries of lists of contacts and/or access means, available from a central server, connected to the network

17. A method according to claim 16, wherein the resources bases and/or the contact bases of each user can be exported from the server.

18. A method according to claim 17, wherein the users are listed including access means to one of said information sources given in their resource base.

19. A method according to claim 18, wherein said users are notified of a possible update of the access means.

20. A software product recorded on a medium useable in a digital processing device and intended for the implementation of the method according to any of the previous claims, whereas said product comprises:
means (16) to provide a user, connected to a digital communication network by said processing device, with a contact base (2), composed of a list of the network addresses of the users of said network, and with a resource base (4), composed of one or several list of access means to information sources available from said network,
means (17) to broadcast a request from said user to the users, some of them or all of them, of its contact base (2),
means (18) to process its resource base (4), to reply to the request.

21. A system for the implementation of the method according to any of the claims 1 to 19 for the selection upon request of one or several information sources available from a communication network such as, notably, the worldwide web, whereas said system comprises a plurality of digital processing devices loaded with said product according to claim 20 and defining a group of users of said network.
